(19) United States
(12) Patent Application Publication
(10) Pub. No.: US 2018/0209502 A1
(43) Pub. Date: Jul. 26, 2018

(54) CHEMICALLY ACTIVATED FRICTION MATERIAL

(71) Applicant: Schaeffler Technologies AG & Co. KG, Herzogenaurach (DE)

(72) Inventors: Rashid FARAHATI, Copley, OH (US); Murat BAKAN, Wooster, OH (US)

(21) Appl. No.: 15/745,622

(22) PCT Filed: Aug. 13, 2015
(86) PCT No.: PCT/US2015/045043

§ 371 Date: Jan. 17, 2018

(51) Int. Cl. F16D 69/02; F16D 13/60

(52) U.S. Cl. CPC F16D 69/028; F16D 2069/002; F16D 13/60

(57) ABSTRACT

A friction material for a clutch or brake, including: a first surface facing in a first direction; a second surface facing a second direction, opposite the first direction; and a body portion sandwiched between the first and second surfaces. The body and the first and second surfaces include fiber material and filler material. The filler material for the first surface includes Si—OH (silanol) and Si—O—Na+ species. A torque converter including a torque converter clutch including: friction material including Si—OH (silanol) and Si—O—Na+ species; and a piston displaceable to engage the friction material with the piston and a cover to transmit torque from the cover to an output hub through the friction material and piston. A method of chemically activating friction material for a clutch or brake, including: exposing friction material, including filler material with Si—O—Si (siloxane), to NaOH (sodium hydroxide); and forming, from the Si—O—Si (siloxane), Si—OH (silanol).

### CROSS-REFERENCE TO RELATED APPLICATIONS

The present application is the U.S. national stage application pursuant to 35 U.S.C. § 371 of International Application No. PCT/US2015/045043, filed Aug. 13, 2015, which application is hereby incorporated by reference in its entirety.

### TECHNICAL FIELD

The present disclosure relates generally to a chemically activated friction material for clutch or brake pads, in particular, friction material exposed to NaOH (sodium hydroxide) to form Si—OH (silanol) and Si—O—Na+ species.

### BACKGROUND

Known friction material for clutches or brakes is composed of fiber material and filler material. The fiber material forms the structure of the friction material and the filler material creates friction. Known friction material uses diatomaceous earth as the filler material. Typically, diatomaceous earth is composed of 80 to 90% silica. It is desirable to increase the adsorption of friction modifiers, included in automatic transmission fluid typically used in clutches, by friction material in the clutch. Such adsorption would desirably increase the gradient of the friction coefficients for the friction material, which improves the performance of the friction material.

### SUMMARY

The present disclosure broadly comprises a friction material for a clutch or brake, including: a first surface facing in a first direction; a second surface facing a second direction, opposite the first direction; and a body portion sandwiched between the first and second surfaces. The body and the first and second surfaces include fiber material and filler material. The filler material for the first surface includes Si—OH (silanol) and Si—O—Na+ species.

The present disclosure broadly comprises a torque converter including: a cover; an impeller connected to the cover; a turbine in fluid communication with the impeller; an output hub arranged to non-rotatably connect to an input shaft for a transmission; and, a torque converter clutch including friction material including Si—OH (silanol) and Si—O—Na+ species and a piston displaceable to engage the friction material with the piston and the cover to transmit torque from the cover to the output hub through the friction material and piston.

The present disclosure broadly comprises a method of chemically activating friction material for a clutch or brake, including: exposing friction material, including filler material with Si—O—Si (siloxane), to NaOH (sodium hydroxide); and forming Si—OH (silanol) from the siloxane.

### BRIEF DESCRIPTION OF THE DRAWINGS

The nature and mode of operation of the present disclosure will now be more fully described in the following detailed description of the present disclosure taken with the accompanying figures, in which:

FIG. 1 is a schematic cross-sectional view of friction material chemically activated using NaOH (sodium hydroxide);

FIGS. 2A and 2B are schematic representations of a chemical interaction of a friction modifier and the friction material shown in FIG. 1;

FIG. 3 is a partial cross-sectional view of an example torque converter including the friction material shown in FIG. 1; and,

FIG. 4 is a graph plotting respective coefficients versus speed for known friction material and friction material chemically activated using NaOH (sodium hydroxide).

### DETAILED DESCRIPTION

At the outset, it should be appreciated that like drawing numbers on different drawing views identify identical, or functionally similar, structural elements of the disclosure. It is to be understood that the disclosure as claimed is not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the present disclosure.

Unless defined otherwise, all technical and scientific terms used herein have the same meaning as commonly understood to one of ordinary skill in the art to which this disclosure belongs. It should be understood that any methods, devices or materials similar or equivalent to those described herein can be used in the practice or testing of the disclosure.

Unless defined otherwise, all technical and scientific terms used herein have the same meaning as commonly understood to one of ordinary skill in the art to which this present disclosure belongs. It should be appreciated that the term “substantially” is synonymous with terms such as “nearly”, “very nearly”, “about”, “approximately”, “around”, “bordering on”, “close to”, “essentially”, “in the neighborhood of”, “in the vicinity of”, etc., and such terms may be used interchangeably as appearing in the specification and claims. It should be appreciated that the term “proximate” is synonymous with terms such as “nearby”, “close”, “adjacent”, “neighboring”, “immediate”, “adjoining”, etc., and such terms may be used interchangeably as appearing in the specification and claims.

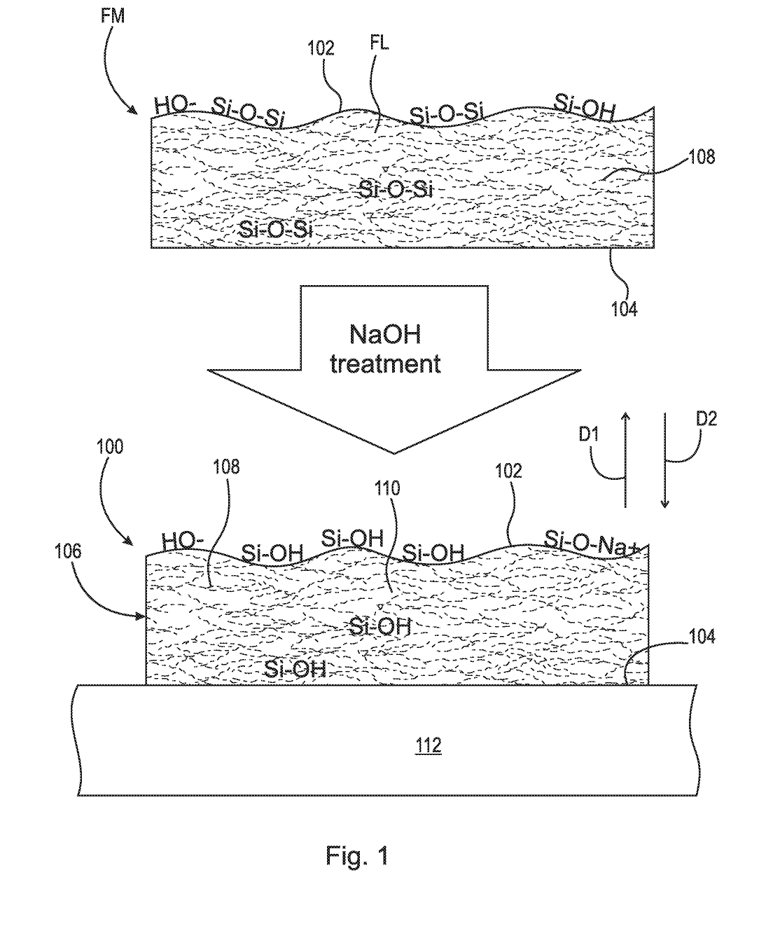

FIG. 1 is a schematic cross-sectional view of friction material 100 chemically activated using NaOH (sodium hydroxide). Friction material 100, for a clutch or brake for example, includes surfaces 102 and 104 and body 106 sandwiched between surfaces 102 and 104. Surface 102 faces in direction D1 and surface 104 faces in direction D2, opposite direction Dl. Material 100 includes fiber material 108 and filler material 110. In an example aspect, the friction material further includes a binder such as phenolic resin (not shown).

FIG. 1 shows: friction material FM prior to exposure to sodium hydroxide; and friction material 100 formed by exposing material FM to sodium hydroxide. Material FM includes fibers 108 and filler material FL. In an example embodiment, material FL is silica-containing material or includes silica-rich particles. Any silica-containing material or silica-rich particles known in the art can be used, wherein the silica-rich particles are amorphous, crystalline, or a combination thereof. In an example embodiment, material FL includes, but is not limited to: Celite®, Celatom®, diatomaceous earth or silicon dioxide. FL includes Si—O—Si (siloxane) and some Si—OH (silanol) groups. HO—(hydroxyl groups) are present on material FM and material 100. In an example embodiment: friction material 100 includes at least 15 percent and no more than 45 percent silica-containing material by weight; the silica-containing material is approximately 90 percent silica by weight; and friction material 100 includes at least approximately 13 percent and no more than approximately 41 percent silica by weight.

Filler material 110 at surface 102 has a higher concentration of silanol than surface 102 of material FM. In an example embodiment, filler material 110 in body 106 has a higher concentration of silanol than in material FM between surfaces 102 and 104. In an example embodiment, filler material 110 at surface 104 has a higher concentration of silanol than surface 104 of material FM.

Filler material 110 at surface 102 includes Si—O—Na+ species not present in or on surface 102 of material FL. In an example embodiment, filler material 110 in body 106 includes Si—O—Na+ species not present in material FM between surfaces 102 and 104. In an example embodiment, filler material 110 at surface 104 includes Si—O—Na+ species not present on surface 104 of material FM.

Exposing friction material FM to sodium hydroxide breaks a bond between Si and O in the siloxane and breaks a hydrogen bond in the sodium hydroxide. The Si—O, formed by breaking the bond in the siloxane, bonds with H (hydrogen), from a solvent or carrier such as water or alcohol, such as methanol or ethanol, to form silanol. Si—O—Na+ species are formed by the Si resulting from breaking the bond in the siloxane. Any excess base is removed by washing the friction material with the same solvent or carrier as used for treatment.

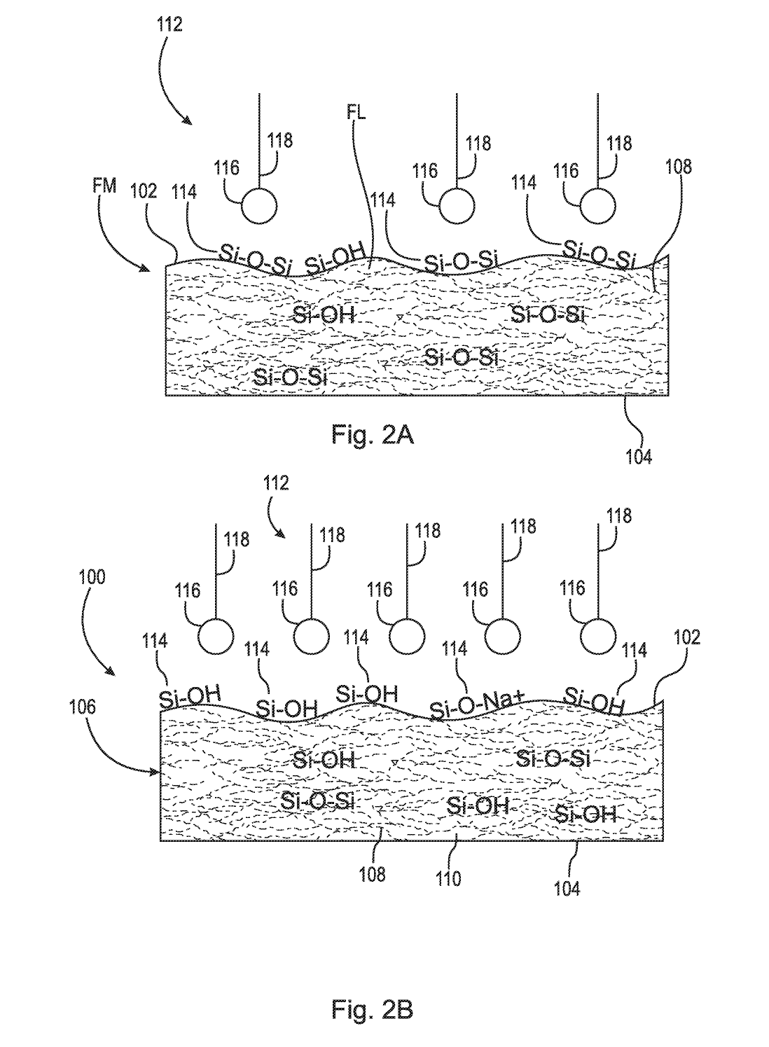

FIGS. 2A and 2B are schematic representations of a chemical interaction of a friction modifier and friction material shown in FIG. 1. In an example embodiment, one or both of surfaces 102 and 104 for material 100 includes fluid layer 112 of oil including a friction modifier. In general, the friction modifier is designed to be adsorbed by active sites 114 for a friction material, such as material FM or material 100, to increase the performance of the friction material. In an example aspect, fluid layer 112 is automatic transmission fluid (ATF) as known in the art. Sites 114 represent surface functional groups.

The friction modifier includes polar heads 116 and respective non-polar tails 118 for polar heads 116. Polar heads 116 bond with active sites 114 as part of the adsorption of the friction modifier by material FM or material 100. In FIG. 2A, which shows material FM, the active sites are formed by siloxane and silanol.

Advantageously, as shown in FIG. 2B, after material FM is exposed to sodium hydroxide, the number of sites 114 for material 100 increases due to the increase in silanol species and the added presence of Si—O—Na+ species (the Si—O—Na+ species form active sites). At least a portion of polar heads 116 in layer 112 is bonded to the silanol species or the Si—O—Na+ species in or on material 100. Thus, due to the increased number of active sites, the adsorption of the friction modifier by material 100 is increased, and the performance of material 100 is enhanced. For example, the dynamic friction coefficient for friction material 100 is increased. Although increases in silanol species and the presence of Si—O—Na+ species is shown only at surface 102 in FIG. 2B, it should be understood that similar increases can be present at surface 104 and in body 106.

In an example embodiment, polar heads 116 include, but are not limited to: an amine group, an amide group, an ester group, or an alcohol group. In an example embodiment, non-polar tails includes a carbon chain. In an example aspect, the friction modifier selected includes a non-polar tail having from and including 16 to 24 carbon atoms.

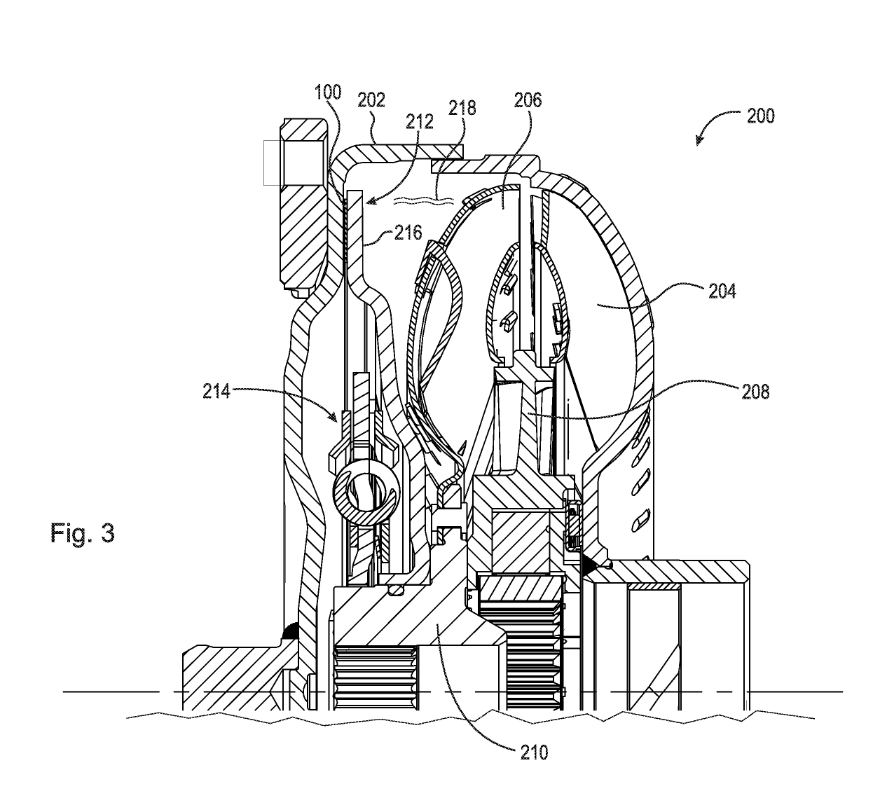

FIG. 3 is a partial cross-sectional view of example torque converter 200 including friction material 100 shown in FIG. 1. Torque converter 200 includes cover 202, impeller 204 connected to the cover, turbine 206 in fluid communication with the impeller, stator 208, output hub 210 arranged to non-rotatably connect to an input shaft (not shown) for a transmission, torque converter clutch 212, and vibration damper 214. Clutch 212 includes friction material 100 and piston 216. As is known in the art, piston 216 is displaceable to engage friction material 100 with piston 216 and cover 202 to transmit torque from cover 202 to output hub 210 through friction material 100 and piston 216.

In an example embodiment, converter 200 includes fluid 218 including polar heads 116 and tails 118. The discussion for FIG. 2B is applicable to material 100 and fluid 218 in FIG. 3. That is, fluid 218 coats material 100 and due to the increase in active sites in and on material 100, the performance of material 100 in clutch 212 increases. In an example aspect, fluid 218 is oil or ATF as known in the art.

Although a particular example configuration of torque converter 200 is shown in FIG. 3, it should be understood that the use of friction material 100 in a torque converter is not limited to a torque converter as configured in FIG. 3. That is, material 100 is usable in any clutch device, using friction material, for any torque converter configuration known in the art.

The following should be viewed in light of FIGS. 1 through 2B. The following describes a method of fabricating friction material for a clutch or brake. A first step exposes friction material, including filler material with Si—O—Si (siloxane), to NaOH (sodium hydroxide). A second step forms Si—OH (silanol) from the siloxane. Exposing the friction material to sodium hydroxide includes: breaking a bond between Si and O in the siloxane. Forming silanol includes bonding Si—O from the siloxane with H (hydrogen). In an example embodiment, forming the silanol includes bonding Si—O from the siloxane with hydrogen from a carrier for the sodium hydroxide. In an example embodiment, the carrier is water or alcohol. In an example embodiment, exposing the friction material to the sodium hydroxide includes forming an Si—O—Na+ species.

The friction material includes a first surface facing in a first direction. Exposing the friction material to sodium hydroxide includes exposing the first surface to sodium hydroxide. Forming silanol from the siloxane includes forming silanol on the first surface. In an example embodiment, a third step forms an Si—O—Na+ species on the first surface.

In an example embodiment, exposing the friction material to sodium hydroxide includes exposing the filler material in a body of the friction material, formed between the first surface and a second surface of the friction material facing in a second direction opposite the first direction, to sodium hydroxide; and forming silanol from the siloxane includes forming silanol in the body. In an example embodiment, a fourth step forms an Si—O—Na+ species in the body.

In an example embodiment, exposing the friction material to sodium hydroxide includes exposing the filler material for a second surface of the friction material, facing in a second direction opposite the first direction, to sodium hydroxide; and forming silanol from the siloxane includes forming silanol on the second surface. In an example embodiment, a fifth step forms an Si—O—Na+ species on the second surface.

In an example embodiment, the friction material includes at least 15 percent and no more than 45 percent silica-containing material by weight; the silica-containing material is approximately 90 percent silica by weight; and the friction material includes at least approximately 13 percent and no more than approximately 41 percent silica by weight.

In an example embodiment, a sixth step adds a layer of oil on the first surface. The oil includes a friction modifier with at least one component with a plurality of polar heads and a respective non-polar tail for each polar head in the plurality of polar heads. In an example embodiment, the plurality of polar heads includes, but is not limited to: an amine group, an amide group, an ester group, or an alcohol group. In an example embodiment, the respective non-polar tail includes a carbon chain.

In an example embodiment, a seventh step bonds at least a portion of the plurality of polar heads to the silanol species or the Si—O—Na+ species.

As noted above, it is desirable to increase, for the friction material, the adsorption of friction modifiers included in oil, such as ATF. Such adsorption advantageously increases the gradient of the friction coefficient for the friction material. The adsorption is at least partly a function of the polarity, or activation, of surface 102, for example a function of sites 114. Increasing the polarity, or activation, of surface 102 increases the ability to adsorb the friction modifiers. For material FM prior to exposure to sodium hydroxide, the siloxane at surface 102 has a relatively low polarity/activation. As seen in FIGS. 1 through 2B, the polarity/activation of surface 102 in material 100 is increased by exposing siloxane to sodium hydroxide. The sodium hydroxide degrades the siloxane to form more polar and activated silanol as well as Si—O—Na+ species. The silanol and Si—O—Na+ species are better able to attract and adsorb the friction modifiers.

Typically, material 100 has a porosity of between 20 and 80 percent, for example, between 50 and 60 percent. Thus, the sodium hydroxide can penetrate surface 102 to degrade siloxane in body 106 and at surface 104 to form silanol and Si—O—Na+ species in body 106 and at surface 104. This penetration and formation of silanol and Si—O—Na+ species is advantageous because surface 102 wears away during use. However, since body 106 includes Si—O—Na+ species and additional silanol, the new surface 102 formed from body 106 always includes additional active sites 114.

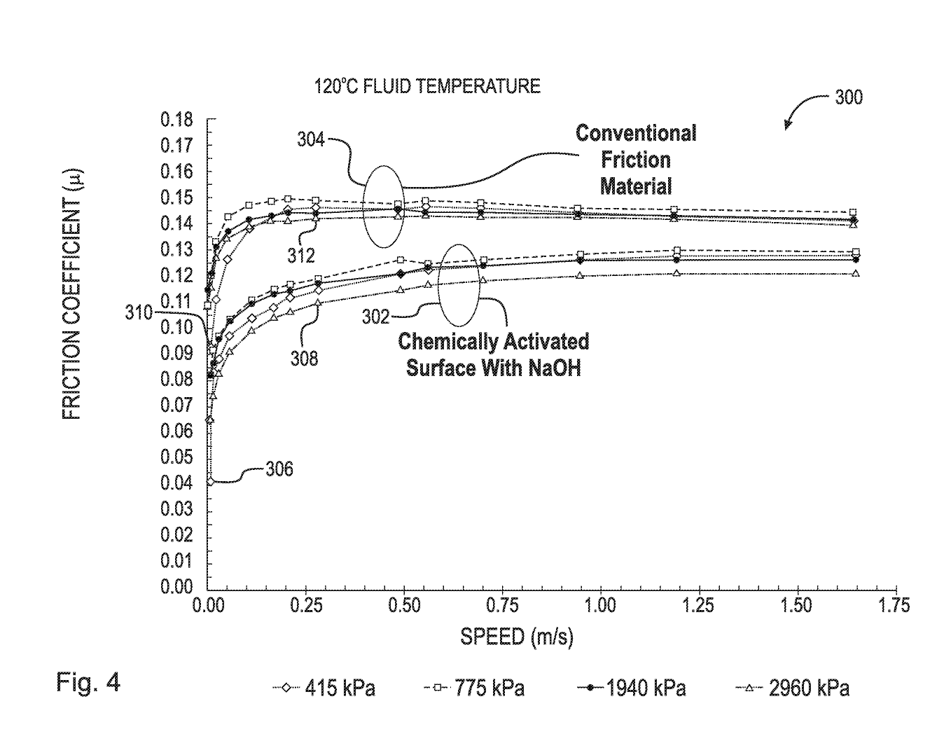

FIG. 4 is graph 300 plotting respective friction coefficients versus speed for known friction material and friction material 100 chemically activated using sodium hydroxide. The speed in the X direction of the graph is the speed of the friction material with respect to a plate with which the friction material is in contact with. For example, the speed is the slip speed between the friction material and the plate. Plot 302 is for friction material 100 chemically activated using sodium hydroxide. Plot 304 is for a known friction material including fiber and a diatomaceous earth filler. Plots 302 and 304 are based on actual tests of the known friction material FM and friction material 100.

As noted above, it is particularly desirable to increase the dynamic friction coefficient gradient for friction material. Advantageously, material 100 increases the dynamic friction coefficient gradient (differential) in comparison to known friction materials for clutches or brakes. For example material 100 at 415 kPa, static coefficient 306 is approximately 0.04 and friction coefficient 308 at approximately 0.30 m/s is approximately 0.11, for a differential of 0.07.

In contrast, for prior art friction material at 415 kPa, static coefficient 310 is approximately 0.09 and friction coefficient 312 at approximately 0.30 m/s is approximately 0.145 for a differential of only 0.055.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

1. A friction material for a clutch or brake, comprising:
a first surface facing in a first direction;
a second surface facing a second direction, opposite the first direction; and,
a body portion sandwiched between the first and second surfaces, wherein:
the body and the first and second surfaces include:
a fiber material; and,
a filler material; and,
the filler material for the first surface includes Si—OH (silanol) and Si—O—Na+ species.

2. The friction material of claim 1, wherein the filler material for the body includes silanol and Si—O—Na+ species.

3. The friction material of claim 2, wherein the filler material for the second surface includes Si—OH (silanol) and Si—O—Na+ species.

4. The friction material of claim 1, wherein the friction material includes at least 13 percent silica by weight and no more than 41 percent silica by weight.

5. The friction material of claim 1, further comprising:
a fluid layer of oil in contact with at least the first surface and including a friction modifier with:
a plurality of polar heads; and,
a respective non-polar tail for each polar head in the plurality of polar heads.

6. The friction material of claim 5, wherein:
the plurality of polar heads is selected from an amine group, an amide group, an ester group, and an alcohol group; and, the respective non-polar tail includes a carbon chain.

7. The friction material of claim 5, wherein at least a portion of the plurality of polar heads is bonded to the silanol species or the Si—O—Na+ species.

8. A torque converter, comprising:
a cover;
an impeller connected to the cover;
a turbine in fluid communication with the impeller;
an output hub arranged to non-rotatably connect to an input shaft for a transmission; and,
a torque converter clutch including:
a friction material including Si—OH (silanol) and Si—O—Na+ species; and,
a piston displaceable to engage the friction material with the piston and the cover to transmit torque from the cover to the output hub through the friction material and piston.

9. The torque converter of claim 8, further comprising:
A fluid layer comprising oil and a friction modifier with a plurality of polar heads and a respective non-polar tail for each polar head in the plurality of polar heads, wherein at least a portion of the plurality of polar heads is bonded to the silanol species or the Si—O—Na+ species.

10. A method of fabricating a friction material for a clutch or brake, comprising:
exposing the friction material, including a filler material with Si—O—Si (siloxane), to NaOH (sodium hydroxide); and,
forming Si—OH (silanol) from the siloxane.

11. The method of claim 10, wherein:
exposing the friction material to the sodium hydroxide includes breaking a bond between Si and O in the siloxane; and,
forming the silanol includes bonding Si—O from the siloxane with H (hydrogen).

12. The method of claim 10, wherein forming the silanol includes bonding Si—O from the siloxane with H (hydrogen) from a carrier for the sodium hydroxide.

13. The method of claim 10, wherein exposing the friction material to the sodium hydroxide includes forming an Si—O—Na+ species.

14. The method of claim 10, wherein:
the friction material includes a first surface;
exposing the friction material to the sodium hydroxide includes exposing the first surface to the sodium hydroxide; and,
forming the silanol from the siloxane includes forming silanol on the first surface, the method further comprising:
forming an Si—O—Na+ species on the first surface.

15. The method of claim 10, wherein:
the friction material includes:
a first surface facing in a first direction;
a second surface facing in a second direction opposite the first direction; and,
a body formed between the first and second surfaces;
exposing the friction material to the sodium hydroxide includes exposing the filler material in the body to the sodium hydroxide; and,
forming the silanol from the siloxane includes forming the silanol in the body, the method, further comprising:
forming an Si—O—Na+ species in the body.

16. The method of claim 10, wherein:
the friction material includes:
a first surface facing in a first direction; and,
a second surface facing in a second direction opposite the first direction;
exposing the friction material to the sodium hydroxide includes exposing the filler material for the second surface to the sodium hydroxide; and,
forming the silanol from the siloxane includes forming silanol on the second surface, the method, further comprising:
forming an Si—O—Na+ species on the second surface.

17. The method of claim 10, wherein the friction material includes at least 13 percent silica by weight and no more than 41 percent silica by weight.

18. The method of claim 10, further comprising:
adding a layer of oil onto at least the first surface, wherein the oil includes a friction modifier with a plurality of polar heads and a respective non-polar tail for each polar head in the plurality of polar heads.

19. The method of claim 18, wherein:
the plurality of polar heads is selected from an amine group, an amide group, an ester group, and an alcohol group; and, the respective non-polar tail includes a carbon chain.

20. The method of claim 18, further comprising:
bonding at least a portion of the plurality of polar heads to the silanol species or the Si—O—Na+ species.
